(19) United States
(12) Patent Application Publication
(10) Pub. No.: US 2026/0142889 A1
(43) Pub. Date: May 21, 2026

(54) SIGNALING OF FINE-TUNING CONFIGURATIONS

(71) Applicant: Nokia Technologies Oy, Espoo (FI)

(72) Inventors: Dick CARRILLO MELGAREJO, Espoo (FI); Afef FEKI, Massy (FR); Muhammad Ikram ASHRAF, Espoo (FI); Oana-Elena BARBU, Aalborg (DK); Athul PRASAD, Naperville, NJ (US)

(21) Appl. No.: 19/121,026

(22) PCT Filed: Sep. 11, 2023
(86) PCT No.: PCT/IB2023/059004

§ 371 Date: Apr. 14, 2025

Related U.S. Application Data
(60) Provisional application No. 63/423,346, filed on Nov. 7, 2022.

(51) Int. Cl. H04L 41/16; H04W 28/02; H04W 28/08

(52) U.S. Cl. CPC H04L 41/16; H04W 28/0226; H04W 28/0925

(57) ABSTRACT

Systems, methods, apparatuses, and computer program products for signaling of fine-tuning configurations. A method may include transmitting, to a first device, information relating to a policy currently applied by a user equipment for modifying a machine-learning model for solving a positioning task. The method may also include receiving, from the first device, a model dataset for training the machine-learning model, and an indication of a triggering condition based on the information for updating the machine-learning model. The method may further include transmitting, to the first device, a request for an updated dataset for fine-tuning based on the triggering condition. In addition, the method may include configuring, based on the triggering condition, an event so that a new dataset request is triggered when an event condition is satisfied.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for signaling of fine-tuning configurations.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include transmitting, to a first device, information relating to a policy currently applied by a user equipment for modifying a machine-learning model for solving a positioning task. The method may also include receiving, from the first device, a model dataset for training the machine-learning model, and an indication of a triggering condition based on the information for updating the machine-learning model. The method may further include transmitting, to the first device, a request for an updated dataset for fine-tuning based on the triggering condition. In addition, the method may include configuring, based on the triggering condition, an event so that a new dataset request is triggered when an event condition is satisfied.

Other example embodiments may be directed to an apparatus. The apparatus may include at least one processor and at least one memory including computer program code. The at least one memory and computer program code may also be configured to, with the at least one processor, cause the apparatus at least to transmit, to a first device, information relating to a policy currently applied by the apparatus for modifying a machine-learning model for solving a positioning task. The apparatus may also be caused to receive, from the first device, a model dataset for training the machine-learning model, and an indication of a triggering condition based on the information for updating the machine-learning mode. The apparatus may further be caused to transmit, to the first device, a request for an updated dataset for fine-tuning based on the triggering condition. In addition, the apparatus may be caused to configure, based on the triggering condition, an event so that a new dataset request is triggered when an event condition is satisfied.

Other example embodiments may be directed to an apparatus. The apparatus may include means for transmitting, to a first device, information relating to a policy currently applied by the apparatus for modifying a machine-learning model for solving a positioning task. The apparatus may further include means for receiving, from the first device, a model dataset for training the machine-learning model, and an indication of a triggering condition based on the information for updating the machine-learning model. The apparatus may also include means for transmitting, to the first device, a request for an updated dataset for fine-tuning based on the triggering condition. In addition, the apparatus may include means for configuring, based on the triggering condition, an event so that a new dataset request is triggered when an event condition is satisfied.

In accordance with other example embodiments, a non-transitory computer readable medium may be encoded with instructions that may, when executed in hardware, perform a method. The method may include transmitting, to a first device, information relating to a policy currently applied by a user equipment for modifying a machine-learning model for solving a positioning task. The method may also include receiving, from the first device, a model dataset for training the machine-learning model, and an indication of a triggering condition based on the information for updating the machine-learning model. The method may further include transmitting, to the first device, a request for an updated dataset for fine-tuning based on the triggering condition. In addition, the method may include configuring, based on the triggering condition, an event so that a new dataset request is triggered when an event condition is satisfied.

Other example embodiments may be directed to a computer program product that performs a method. The method may include transmitting, to a first device, information relating to a policy currently applied by a user equipment for modifying a machine-learning model for solving a positioning task. The method may also include receiving, from the first device, a model dataset for training the machine-learning model, and an indication of a triggering condition based on the information for updating the machine-learning model. The method may further include transmitting, to the first device, a request for an updated dataset for fine-tuning based on the triggering condition. In addition, the method may include configuring, based on the triggering condition, an event so that a new dataset request is triggered when an event condition is satisfied.

Other example embodiments may be directed to an apparatus that may include circuitry configured to transmit to a first device, information relating to a policy currently applied by the apparatus for modifying a machine-learning model for solving a positioning task. The apparatus may also include circuitry configured to receive, from the first device, a model dataset for training the machine-learning model, and an indication of a triggering condition based on the information for updating the machine-learning model. The apparatus may further include circuitry configured to transmit, to the first device, a request for an updated dataset for fine-tuning based on the triggering condition. In addition, the apparatus may include circuitry configured to configure, based on the triggering condition, an event so that a new dataset request is triggered when an event condition is satisfied.

Certain example embodiments may be directed to a method. The method may include transmitting, to a user equipment, a query requesting information related to a policy currently applied by the user equipment for modifying a machine-learning model for solving a positioning task. The method may also include receiving, from the user equipment, a response to the query, wherein the response may include information relating to the. The method may further include determining a model dataset to share with the user equipment based on the information. In addition, the method may include transmitting, to the user equipment, the model dataset and an indication of a triggering condition. Further, the method may include receiving, from the user equipment, a request for an updated dataset for fine-tuning.

Other example embodiments may be directed to an apparatus. The apparatus may include at least one processor and at least one memory including computer program code. The at least one memory and computer program code may be configured to, with the at least one processor, cause the apparatus at least to transmit, to a user equipment, a query requesting information related to a policy currently applied by the user equipment for modifying a machine-learning model for solving a positioning task. The apparatus may also be caused to receive, from the user equipment, a response to the query, wherein the response may include information relating to the policy. The apparatus may further be caused to determine a model dataset to share with the user equipment based on the information. In addition, the apparatus may be caused to transmit, to the user equipment, the model dataset and an indication of a triggering condition. Further, the apparatus may be caused to receive, from the user equipment, a request for an updated dataset for fine-tuning.

Other example embodiments may be directed to an apparatus. The apparatus may include means for transmitting, to a user equipment, a query requesting information related to a policy currently applied by the user equipment for modifying a machine-learning model for solving a positioning task. The apparatus may also include means for receiving, from the user equipment, a response to the query, wherein the response may include information relating to the policy. The apparatus may further include means for determining a model dataset to share with the user equipment based on the information. In addition, the apparatus may include means for transmitting, to the user equipment, the model dataset and an indication of a triggering condition. Further, the apparatus may include means for receiving, from the user equipment, a request for an updated dataset for fine-tuning.

In accordance with other example embodiments, a non-transitory computer readable medium may be encoded with instructions that may, when executed in hardware, perform a method. The method may include transmitting, to a user equipment, a query requesting information related to a policy currently applied by the user equipment for modifying a machine-learning model for solving a positioning task. The method may also include receiving, from the user equipment, a response to the query, wherein the response may include information relating to the. The method may further include determining a model dataset to share with the user equipment based on the information. In addition, the method may include transmitting, to the user equipment, the model dataset and an indication of a triggering condition. Further, the method may include receiving, from the user equipment, a request for an updated dataset for fine-tuning.

Other example embodiments may be directed to a computer program product that performs a method. The method may include transmitting, to a user equipment, a query requesting information related to a policy currently applied by the user equipment for modifying a machine-learning model for solving a positioning task. The method may also include receiving, from the user equipment, a response to the query, wherein the response may include information relating to the. The method may further include determining a model dataset to share with the user equipment based on the information. In addition, the method may include transmitting, to the user equipment, the model dataset and an indication of a triggering condition. Further, the method may include receiving, from the user equipment, a request for an updated dataset for fine-tuning.

Other example embodiments may be directed to an apparatus that may include circuitry configured to transmit to a user equipment, a query requesting information related to a policy currently applied by the user equipment for modifying a machine-learning model for solving a positioning task. The apparatus may also include circuitry configured to receive, from the user equipment, a response to the query, wherein the response may include information relating to the policy. The apparatus may further include circuitry configured to determine a model dataset to share with the user equipment based on the information. In addition, the apparatus may include circuitry configured to transmit, to the user equipment, the model dataset and an indication of a triggering condition. Further, the apparatus may include circuitry configured to receive, from the user equipment, a request for an updated dataset for fine-tuning.

Certain example embodiments may be directed to a method. The method may include receiving, from a first device, a query requesting a dataset preference. The method may also include transmitting, to the first device, a response to the query, the response including the dataset preference. The method may further include receiving, from the first device, a model dataset and an indication of a triggering condition based on the dataset preference. In addition, the method may include transmitting, to the first device, a request for an updated dataset for fine-tuning based on the triggering condition.

Other example embodiments may be directed to an apparatus. The apparatus may include at least one processor and at least one memory including computer program code. The at least one memory and computer program code may be configured to, with the at least one processor, cause the apparatus at least to receive, from a first device, a query requesting a dataset preference. The apparatus may also be caused to transmit, to the first device, a response to the query, the response may include the dataset preference. The apparatus may further be caused to receive, from the first device, a model dataset and an indication of a triggering condition based on the dataset preference. In addition, the apparatus may be caused to transmit, to the first device, a request for an updated dataset for fine-tuning based on the triggering condition.

Other example embodiments may be directed to an apparatus. The apparatus may include means for receiving, from a first device, a query requesting a dataset preference. The apparatus may also include means for transmitting, to the first device, a response to the query, the response may include the dataset preference. The apparatus may further include means for receiving, from the first device, a model dataset and an indication of a triggering condition based on the dataset preference. In addition, the apparatus may include means for transmitting, to the first device, a request for an updated dataset for fine-tuning based on the triggering condition.

In accordance with other example embodiments, a non-transitory computer readable medium may be encoded with instructions that may, when executed in hardware, perform a method. The method may include receiving, from a first device, a query requesting a dataset preference. The method may also include transmitting, to the first device, a response to the query, the response including the dataset preference. The method may further include receiving, from the first device, a model dataset and an indication of a triggering condition based on the dataset preference. In addition, the method may include transmitting, to the first device, a request for an updated dataset for fine-tuning based on the triggering condition.

Other example embodiments may be directed to a computer program product that performs a method. The method may include receiving, from a first device, a query requesting a dataset preference. The method may also include transmitting, to the first device, a response to the query, the response including the dataset preference. The method may further include receiving, from the first device, a model dataset and an indication of a triggering condition based on the dataset preference. In addition, the method may include transmitting, to the first device, a request for an updated dataset for fine-tuning based on the triggering condition.

Other example embodiments may be directed to an apparatus that may include circuitry configured to receive, from a first device, a query requesting a dataset preference. The apparatus may also include circuitry configured to transmit, to the first device, a response to the query, the response may include the dataset preference. The apparatus may further include circuitry configured to receive, from the first device, a model dataset and an indication of a triggering condition based on the dataset preference. In addition, the apparatus may include circuitry configured to transmit, to the first device, a request for an updated dataset for fine-tuning based on the triggering condition.

Certain example embodiments may be directed to a method. The method may include transmitting, to a user equipment, a query requesting a dataset preference. The method may also include receiving, from the user equipment, a response to the query, the response may include the dataset preference. The method may further include determining a model dataset to share with the user equipment based on the dataset preference. In addition, the method may include transmitting, to the user equipment, the model dataset and an indication of a triggering condition based on the dataset preference. Further, the method may include receiving, from the user equipment, a request for an updated dataset for fine-tuning.

Other example embodiments may be directed to an apparatus. The apparatus may include at least one processor and at least one memory including computer program code. The at least one memory and computer program code may be configured to, with the at least one processor, cause the apparatus at least to transmit, to a user equipment, a query requesting a dataset preference. The apparatus may also be caused to receive, from the user equipment, a response to the query, the response may include the dataset preference. The apparatus may further be caused to determine a model dataset to share with the user equipment based on the dataset preference. In addition, the apparatus may be caused to transmit, to the user equipment, the model dataset and an indication of a triggering condition based on the dataset preference. Further, the apparatus may be caused to receive, from the user equipment, a request for an updated dataset for fine-tuning.

Other example embodiments may be directed to an apparatus. The apparatus may include means for transmitting, to a user equipment, a query requesting a dataset preference. The apparatus may also include means for receiving, from the user equipment, a response to the query, the response may include the dataset preference. The apparatus may further include means for determining a model dataset to share with the user equipment based on the dataset preference. In addition, the apparatus may include means for transmitting, to the user equipment, the model dataset and an indication of a triggering condition based on the dataset preference. Further, the apparatus may include means for receiving, from the user equipment, a request for an updated dataset for fine-tuning.

In accordance with other example embodiments, a non-transitory computer readable medium may be encoded with instructions that may, when executed in hardware, perform a method. The method may include transmitting, to a user equipment, a query requesting a dataset preference. The method may also include receiving, from the user equipment, a response to the query, the response may include the dataset preference. The method may further include determining a model dataset to share with the user equipment based on the dataset preference. In addition, the method may include transmitting, to the user equipment, the model dataset and an indication of a triggering condition based on the dataset preference. Further, the method may include receiving, from the user equipment, a request for an updated dataset for fine-tuning.

Other example embodiments may be directed to a computer program product that performs a method. The method may include transmitting, to a user equipment, a query requesting a dataset preference. The method may also include receiving, from the user equipment, a response to the query, the response may include the dataset preference. The method may further include determining a model dataset to share with the user equipment based on the dataset preference. In addition, the method may include transmitting, to the user equipment, the model dataset and an indication of a triggering condition based on the dataset preference. Further, the method may include receiving, from the user equipment, a request for an updated dataset for fine-tuning.

Other example embodiments may be directed to an apparatus that may include circuitry configured to transmit, to a user equipment, a query requesting a dataset preference. The apparatus may also include circuitry configured to receive, from the user equipment, a response to the query, the response may include the dataset preference. The apparatus may further include circuitry configured to determine a model dataset to share with the user equipment based on the dataset preference. In addition, the apparatus may be caused to transmit, to the user equipment, the model dataset and an indication of a triggering condition based on the dataset preference. Further, the apparatus may include circuitry configured to receive, from the user equipment, a request for an updated dataset for fine-tuning.

Certain example embodiments may be directed to a method. The method may include transmitting, to a user equipment, a preference of a policy to be applied at the user equipment for fine-tuning. The method may also include determining a model dataset to share with the user equipment based on the policy. The method may further include transmitting, to the user equipment, the model dataset and an indication of a triggering condition based on the policy. In addition, the method may include receiving, from the user equipment, a request for an updated dataset for fine-tuning.

Other example embodiments may be directed to an apparatus. The apparatus may include at least one processor and at least one memory including computer program code. The at least one memory and computer program code may be configured to, with the at least one processor, cause the apparatus at least to transmit to a user equipment, a preference of a policy to be applied at the user equipment for fine-tuning. The apparatus may also be caused to determine a model dataset to share with the user equipment based on the policy. The apparatus may further be caused to transmit, to the user equipment, the model dataset and an indication of a triggering condition based on the policy. In addition, the apparatus may be caused to receive, from the user equipment, a request for an updated dataset for fine-tuning.

Other example embodiments may be directed to an apparatus. The apparatus may include means for transmitting, to a user equipment, a preference of a policy to be applied at the user equipment for fine-tuning. The apparatus may also include means for determining a model dataset to share with the user equipment based on the policy. The apparatus may further include means for transmitting, to the user equipment, the model dataset and an indication of a triggering condition based on the policy. In addition, the apparatus may include means for receiving, from the user equipment, a request for an updated dataset for fine-tuning.

In accordance with other example embodiments, a non-transitory computer readable medium may be encoded with instructions that may, when executed in hardware, perform a method. The method may include transmitting, to a user equipment, a preference of a policy to be applied at the user equipment for fine-tuning. The method may also include determining a model dataset to share with the user equipment based on the policy. The method may further include transmitting, to the user equipment, the model dataset and an indication of a triggering condition based on the policy. In addition, the method may include receiving, from the user equipment, a request for an updated dataset for fine-tuning.

Other example embodiments may be directed to a computer program product that performs a method. The method may include transmitting, to a user equipment, a preference of a policy to be applied at the user equipment for fine-tuning. The method may also include determining a model dataset to share with the user equipment based on the policy. The method may further include transmitting, to the user equipment, the model dataset and an indication of a triggering condition based on the policy. In addition, the method may include receiving, from the user equipment, a request for an updated dataset for fine-tuning.

Other example embodiments may be directed to an apparatus that may include circuitry configured to transmit, to a user equipment, a preference of a policy to be applied at the user equipment for fine-tuning. The apparatus may also include circuitry configured to determine a model dataset to share with the user equipment based on the policy. The apparatus may further include circuitry configured to transmit, to the user equipment, the model dataset and an indication of a triggering condition based on the policy. In addition, the apparatus may include circuitry configured to receive, from the user equipment, a request for an updated dataset for fine-tuning.

Certain example embodiments may be directed to a method. The method may include transmitting, to a user equipment, a dataset preference. The method may also include determining a model dataset to share with the user equipment based on the dataset preference. The method may further include transmitting, to the user equipment, the model dataset and an indication of a triggering condition based on the dataset preference. In addition, the method may include receiving, from the user equipment, a request for an updated dataset for fine-tuning.

Other example embodiments may be directed to an apparatus. The apparatus may include at least one processor and at least one memory including computer program code. The at least one memory and computer program code may be configured to, with the at least one processor, cause the apparatus at least to transmit, to a user equipment, a dataset preference. The apparatus may also be caused to determine a model dataset to share with the user equipment based on the dataset preference. The apparatus may further be caused to transmit, to the user equipment, the model dataset and an indication of a triggering condition based on the dataset preference. In addition, the apparatus may be caused to receive, from the user equipment, a request for an updated dataset for fine-tuning.

Other example embodiments may be directed to an apparatus. The apparatus may include means for transmitting, to a user equipment, a dataset preference. The apparatus may also include means for determining a model dataset to share with the user equipment based on the dataset preference. The apparatus may further include means for transmitting, to the user equipment, the model dataset and an indication of a triggering condition based on the dataset preference. In addition, the apparatus may include means for receiving, from the user equipment, a request for an updated dataset for fine-tuning.

In accordance with other example embodiments, a non-transitory computer readable medium may be encoded with instructions that may, when executed in hardware, perform a method. The method may include transmitting, to a user equipment, a dataset preference. The method may also include determining a model dataset to share with the user equipment based on the dataset preference. The method may further include transmitting, to the user equipment, the model dataset and an indication of a triggering condition based on the dataset preference. In addition, the method may include receiving, from the user equipment, a request for an updated dataset for fine-tuning.

Other example embodiments may be directed to a computer program product that performs a method. The method may include transmitting, to a user equipment, a dataset preference. The method may also include determining a model dataset to share with the user equipment based on the dataset preference. The method may further include transmitting, to the user equipment, the model dataset and an indication of a triggering condition based on the dataset preference. In addition, the method may include receiving, from the user equipment, a request for an updated dataset for fine-tuning.

Other example embodiments may be directed to an apparatus that may include circuitry configured to transmit, to a user equipment, a dataset preference. The apparatus may also include circuitry configured to determine a model dataset to share with the user equipment based on the dataset preference. The apparatus may further include circuitry configured to transmit, to the user equipment, the model dataset and an indication of a triggering condition based on the dataset preference. In addition, the apparatus may include circuitry configured to receive, from the user equipment, a request for an updated dataset for fine-tuning.

### BRIEF DESCRIPTION OF THE DRAWINGS:

For proper understanding of example embodiments, reference should be made to the accompanying drawings, wherein:

FIG. 1 illustrates an example one-step positioning approach for AI/ML-based solutions.

FIG. 2 illustrates an example two-step positioning approach for AI/ML-based solutions.

FIG. 3 illustrates an example charging data function (CDF) of a 2D/horizontal positioning error graph.

FIG. 4 illustrates another example CDF of the 2D/horizontal positioning error graph.

FIG. 5 illustrates an example overview of a problem scenario where the UE moves back to the original environment where the model was initially trained.

FIG. 6(a) illustrates an example machine-learning (ML) model fine-tuning through weights update, according to certain example embodiments.

FIG. 6(b) illustrates an example ML model fine-tuning through new layer addition, according to certain example embodiments.

FIG. 7(a) illustrates an example model fine-tuning procedure, according to certain example embodiments.

FIG. 7(b) illustrates an example model tuning with a mixed dataset, according to certain example embodiments.

FIG. 8 illustrates an example signal flow between a user equipment (UE) and a gNB/logical management function (LMF), according to certain example embodiments.

FIG. 9 illustrates another example signal flow between a UE and a gNB/LMF, according to certain example embodiments.

FIG. 10 illustrates an example signal flow between a UE and a gNB/LMF, according to certain example embodiments.

FIG. 11 illustrates an example signal flow between a UE and a gNB/LMF, according to certain example embodiments.

FIG. 12 illustrates an example model performance evaluation, according to certain example embodiments.

FIG. 13 illustrates another example model performance evaluation according to certain example embodiments.

FIG. 14 illustrates an example flow diagram of a method, according to certain example embodiments.

FIG. 15 illustrates an example flow diagram of another method, according to certain example embodiments.

FIG. 16 illustrates an example flow diagram of a further method, according to certain example embodiments.

FIG. 17 illustrates an example flow diagram of yet another method, according to certain example embodiments.

FIG. 18 illustrates an example flow diagram of yet a further method, according to certain example embodiments.

FIG. 19 illustrates an example flow diagram of another method, according to certain example embodiments.

FIG. 20 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for signaling of fine-tuning configurations. For instance, certain example embodiments may be directed to a signaling of fine-tuning configurations to improve model generalization performance.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

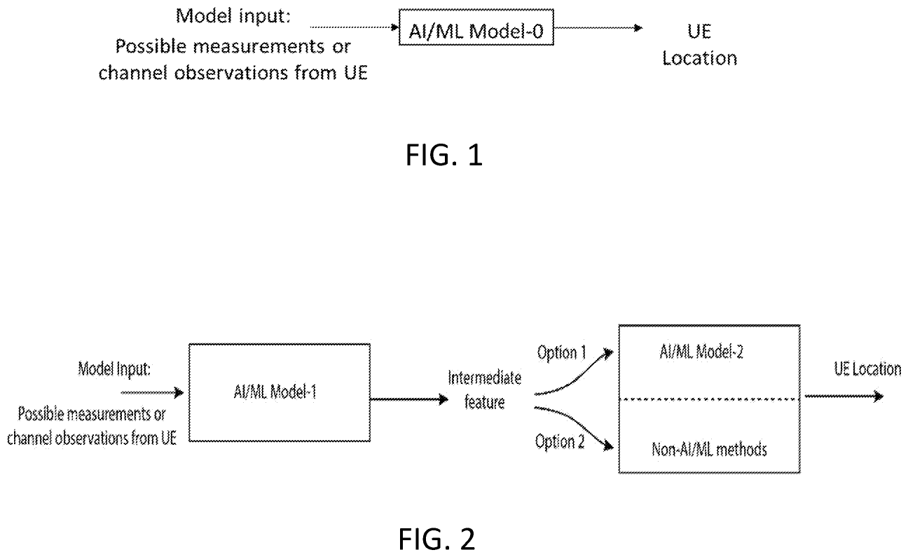

The technical specification of 3^{rd} Generation Partnership Project (3GPP) describes artificial intelligence/machine-learning (AI/ML) for air interface, where one use case may include positioning accuracy enhancements with the use of AI/ML. Such positioning accuracy enhancements may be applicable in various scenarios including, for example, those with heavy non-line-of-sight (NLOS) conditions. FIG. 1 illustrates an example one-step positioning approach for AI/ML-based solutions. As illustrated in FIG. 1, model input including possible measurements or channel observations from a user equipment (UE) may be provided to an AI/ML Model-0. The AI/ML Model-0 may subsequently use the provided input to determine the location of the UE.

When reporting evaluation results with direct AI/ML positioning and/or AI/ML assisted positioning, there may be provided a one-sided model (e.g., direct AI/ML positioning) or a two-sided model (e.g., AI/ML assisted positioning). In the one-sided model (i.e., UE-side model or network-side model), a determination is made as to which side the inference is performed (e.g., UE or network), and any details specific to the side that performs the AI/ML inference. In certain example embodiments, inference may correspond to the process of using the ML model to generate an inference output. The inference node may imply the node where the trained ML model is deployed and the node where the model inputs are provided to generate the model output. However, in the two-sided model, a report is made as to which side (e.g., UE or network) performs the first part of interference, and which side (e.g., network or UE) performs the remaining part of the inference.

As to the one-step positioning approach, the AI/ML model may be hosted/deployed at the UE or network/location management function (LMF). Inputs for this AI/ML model may include various channel observations such as reference signal received power (RSRP) measurements, configuration information request (CIR), cell IDs, beam IDs, angle of arrival/departure, etc. These values may be provided as an input to an AI/ML model (e.g., for Model-0) which may provide the UE location as an output. The advantage of this approach may be that it may have a potential for high-accuracy performance even in heavy NLOS conditions as well as relative simplicity in terms of training and deployment-with a single node being used for such scenarios. However, the disadvantage in this approach is that it may be sensitive to changes in the propagation environment. In this regard, frequency-selective fading channels result in a poor generalization of the trained model and higher computational complexity required to achieve significantly high positioning accuracy and scenario dependence for model usage.

FIG. 2 illustrates an example two-step positioning approach for AI/ML-based solutions. Two options may be presented in the two-step positioning approach. In one option, there may be separate AI/ML models model-1 and model-2 hosted at the UE and at the network/LMF, respectively. The models may have intermediate features exchanged between the UE and the network. Alternatively, in a second option, an AI/ML model (model-1) may be hosted at the UE or the network. The AI/ML model may be hosted with possible intermediate features along with improved channel observations sent to classical methods hosted at the network which may then derive the UE location. In both options (one-and two-step), each step may be realized in separate entities or in a single entity. Moreover, instead of the UE and the network, a sidelink scenario may also be considered for example, with model-1 at UE-1 and model-2 at UE-2. As shown in FIG. 2, the one-step approach may also be called a direct AI/ML positioning approach, and the two-step approach may be called an indirect AI/ML positioning.

3GPP specifications describe model inputs and assistance signaling for model monitoring and inference. Agreements made in 3GPP focus on data collection aspects that enable the collection of diverse datasets for training AI/ML models, possible assistance information from the network to the UE for training (in case of UE-side model training and inference), and reports or feedback from the UE to the network for training and inference (in case of network-side training and inference). However, as described herein, certain example embodiments may focus on all three of these aspects where the UE location may be determined either at the LMF or UE, utilizing either direct or AI/ML-assisted positioning methods.

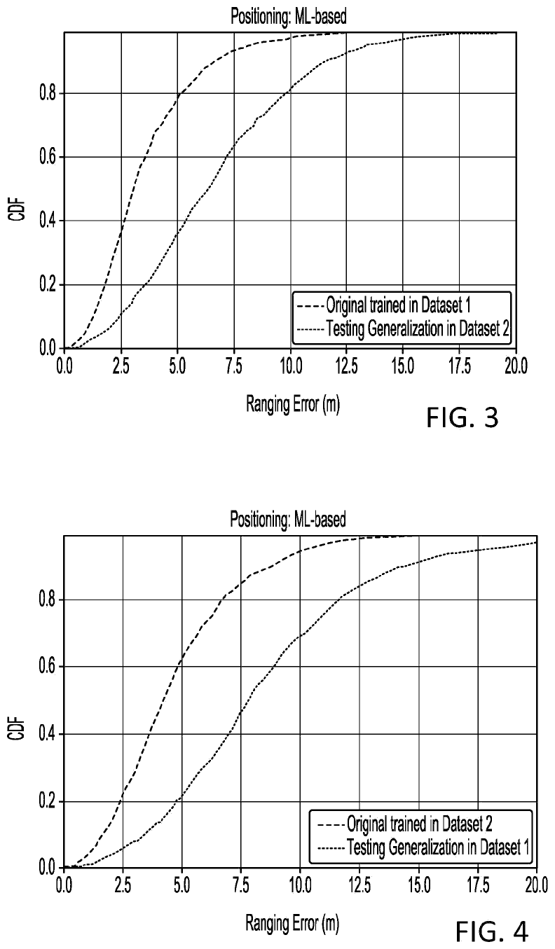

As described in RAN1, model generalization may evaluate how well a model is trained using a particular dataset-reflection of a certain environmental condition/scenario may perform in a different scenario/setting. Specifically, ML model performance may be evaluated using different simulation drops, clutter density parameters, and network synchronization errors as part of hardware implementation imperfections. A simulation drop may imply that certain parameters within the simulation setting is held constant—such as shadow fading, UE location (or at least initial location), etc. In other words, the simulation drop may refer to channel realizations related to fixed UEs and BSs locations and some radio characteristics in the Monte Carlo simulation. The clutter density parameter may indicate the amount of clutter or blockages that are present between the UE and the TRP. Additionally, the clutter density parameter may define industrial scenarios based on the density of clutters. Network synchronization errors may imply possible hardware implementation imperfections that causes timing errors to occur between the network nodes and the UEs. Additionally, the network synchronization errors may refer to time synchronization misalignment between the receiver and the transmitter. Certain observations have been made on datasets for positioning model training and inference. For instance, FIG. 3 illustrates an example cumulative distribution function (CDF) of a 2D/horizontal positioning error graph. In particular, FIG. 3 illustrates the CDF of the 2D/horizontal positioning error originally trained with a dataset 1 (density cluttering of 40% in industrial scenarios). The generalization capabilities of the AI/ML model already trained is tested with dataset 2 with a density cluttering of 60%. FIG. 3 also illustrates a significant degradation of model performance without specific solutions targeting model generalization related issues.

Additionally, FIG. 4 illustrates another example CDF of the 2D/horizontal positioning error graph. In particular, FIG. 4 illustrates the CDF of the 2D/horizontal positioning error originally trained with dataset 2 (density cluttering of 60% in industrial scenarios). The generalization capabilities of the AI/ML model in this example may already be trained and tested with dataset 1 (density cluttering of 40%). As illustrated in FIG. 4, datasets 1 and 2 may be described as essentially two different datasets with different clutter parameters used for model training and inference/testing. For instance, dataset 1 may be defined by a clutter density of 40%, clutter height of 2 m, clutter ceiling height of 10 m, and clutter size of 2 m. Additionally, dataset 2 may be defined by a clutter density of 60%, clutter height of 6 m, clutter ceiling height of 10 m, and clutter size of 2 m.

From FIGS. 3 and 4, it may be observed that the generalization performance of ML models may be poor for direct AI/ML positioning. A practical implication of this issue may be that for UE-based model training and inference, if the model is trained using a dataset from scenario-1, the obtained accuracy when applying inference on the dataset from scenario 2, the model performance in terms of horizontal positioning accuracy, may be significantly lower.

In view of the above-described challenges, one possible solution may include fine-tuning, where the ML model may be fine-tuned (i.e., more weights are updated or new neural networks trained; current neural networks are updated, and training new complementary neural networks) using a dataset from the different scenarios. This may imply that the model trained using dataset 1 may be fine-tuned using dataset 2, which provides improvements in terms of the inference performance with different scenario settings. In other words, for initial training, the parameter weights of all neural networks may be empty or initialized with random values. However, in fine-tuning, the parameter weights of all neural networks may have representative values obtained during an initial training with an initial dataset. These weights may be updated when the fine-tuning is performed using the new dataset. There may be various factors related to fine-tuning, especially in the context of model performance in real settings that has been overlooked by the current discussions in 3GPP RAN1 .

In ML, model generalization may refer to the capability of the given AI/ML model to adapt and react to new or previously unseen data. The main advantage of generalization may be to find the best trade-off between underfitting and overfitting in order to achieve the best performance. In this sense, model-fine-tuning may be proposed as a potential solution where the model trained using an initial dataset that represents a particular environment is further updated using a dataset from a new setting (i.e., environment). The new dataset may have the same input and output parameters as the original dataset used to train the model. For instance, the new dataset may include a collection of features/information/data. However, the new dataset may be taken from a different environment or scenario (i.e., new environment) with characteristics that are not present in the original dataset. Additionally, the new dataset may be used to fine-tune the AI/ML model. However, this approach may have significant drawbacks especially in terms of performance degradation in the original setting where the model was initially trained. This phenomenon may typically occur in supervised learning when the model is subjected to continual learning strategies, and may be known as catastrophic forgetting (i.e., the model learns how to behave in new conditions, and forgets how to deal with past conditions). As a result, when such past conditions occur again, the model is no longer able to adapt to them.

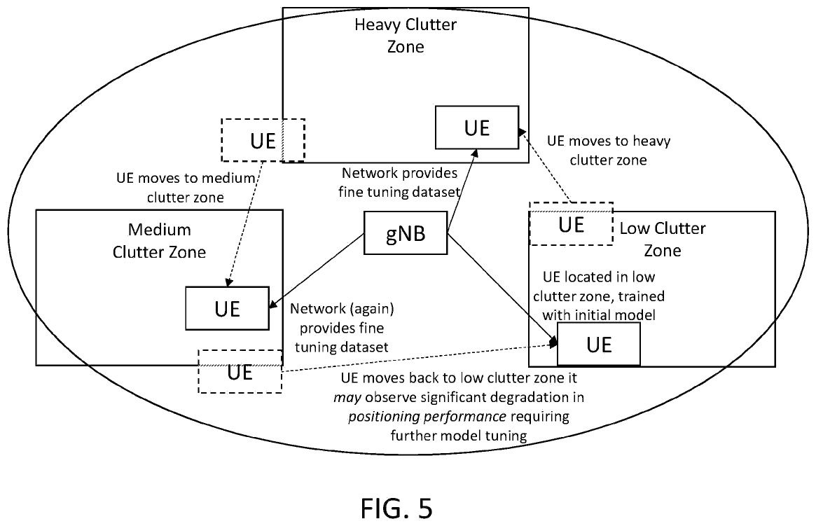

Current considerations related to fine-tuning do not take the above-described aspects into account Additionally, realistic mobility patterns whereby the UE moves between different environmental settings have also not been considered since this may trigger a significant amount of mode fine-tuning related signaling and data exchange-including the scenario where the UE moves back to the original environment where the model was initially trained. For instance, FIG. 5 illustrates an example overview of a problem scenario where the UE moves back to the original environment where the model was initially trained. In particular, FIG. 5 illustrates an example where the UE would trigger multiple fine-tuning related signaling, resulting in model performance degradation after each mobility event. Another aspect related to model fine-tuning may relate to the parameters used for fine-tuning the ML model, which may also impact the model generalization performance. Additionally, fine-tuning may be expected to be applied to UE-based positioning methods, particularly for direct AI/ML positioning mechanisms. Thus, in view of the above-described drawbacks, certain example embodiments may provide solutions to how model generalization performance may be improved (i.e., to avoid catastrophic forgetting). For instance, certain example embodiments may use assistance information from the network to the UE, with minimal overhead in terms of control signaling and dataset exchange for UE-based positioning methods.

According to certain example embodiments, a network may request appropriate information from the UE in order to share the dataset required for model training at the UE. For instance, for UE-based model training and inference, the network may request information regarding the fine-tuning policy applied by the UE. The purpose of such a query/request by the network may be to determine whether the underlying architecture is fixed between updates (e.g., in terms of whether the model weights are updated, or the update introduces new neural network layers that need to be trained). Thus, the fine-tuning policy could imply the configurations that the UE uses to fine-tune the model. This could include information regarding whether the UE is simply updating the weights of the existing model or training new neural network layers. In other words, the fine-tuning policy may correspond to instructions indicative of how the model weights may be updated. In some example embodiments, the fine-tuning policy may include a set(s) of instructions indicative of how the layers may be added to the model.

In certain example embodiments, based on the query results of the fine-tuning policy applied by the UE, the network may determine whether to share a training dataset based on the fine-tuning mechanism applied. In some example embodiments, the dataset may include information such as an estimated mobility profile, environmental settings of the UE, inference output, and others. The dataset could contain labeled values related to angular/time/power-based measurements as model inputs and UE location as model output as well. Further, the estimated mobility profile may include information of previous locations in which the UE was located, and the environmental settings of the UE may include the UE's characteristics on a specific environment. Additionally, the inference output may correspond to the feature that is used as output in the Al'ML model. For example, in certain example embodiments, the inference output may include the horizontal position (x and y coordinates) of the UE.

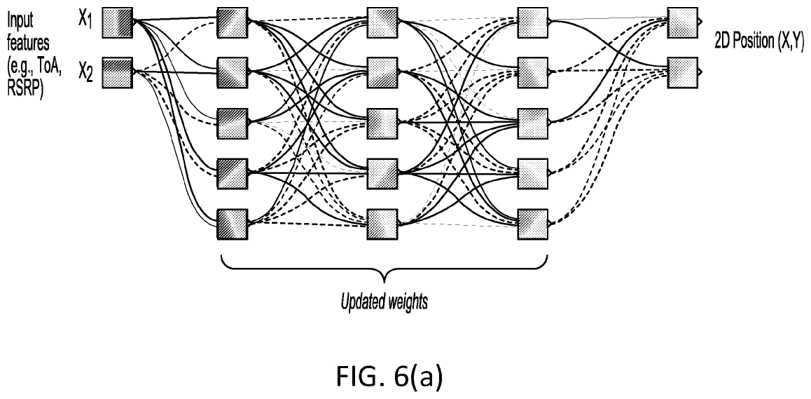

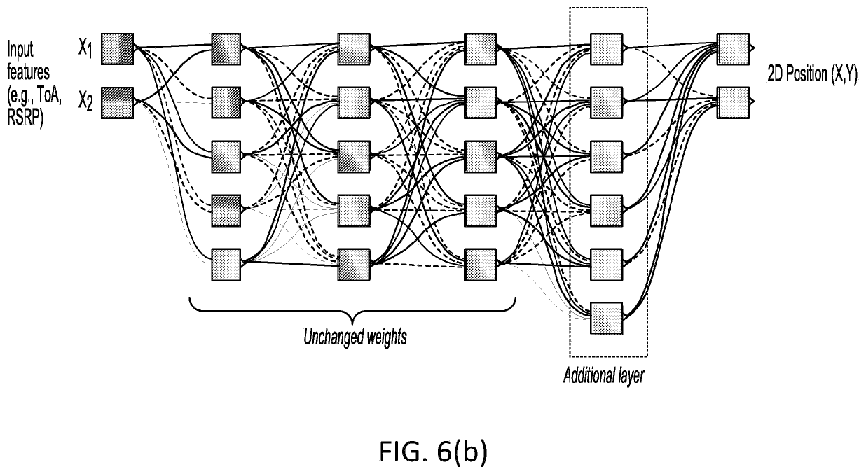

FIG. 6(a) illustrates an example ML model fine-tuning through weights update, according to certain example embodiments. As illustrated in FIG. 6(a), if the fine-tuning mechanism applied by the UE is to update the model weights upon reception of the dataset, the network may share the dataset specific to the environmental settings of the UE. Here, the environmental setting may include data samples collected from different clutter settings, network synchronization error values, different scenario setting-for example, indoor factory with dense or sparse clutter, height, etc., or urban micro and macro scenarios. Additionally, the network may configure a first new triggering configuration/mechanism that the UE may use to request a new fine-tuning dataset. In some example embodiments, the UE may also use the first new triggering configuration/mechanism when the UE moves from a current environment setting to a previous environment setting for which initial training or a fine-tuning dataset was already provided.

FIG. 6(b) illustrates an example ML model fine-tuning through new layer addition, according to certain example embodiments. As illustrated in FIG. 6(b), if the UE applies the fine-tuning dataset to train new neural network layers, the network may share a dataset that is specific to the environmental setting of the UE, and configure a second new triggering configuration/mechanism that the UE may use to request a new fine-tuning dataset. In some example embodiments, the UE may use the second new triggering configuration/mechanism only if the UE moves from a current environment to a new environment with different clutter densities, new zones within the network, etc. According to certain example embodiments, the clutter densities may correspond to parameters of a scenario where there is dense deployment of factory equipment which frequently impedes the UE's line-of-sight link with the TRP/gNB. Additionally, new zones could imply areas within the regions that the UE moves to which has different radio characteristics-for example, from factory floor to warehouse which might have different line-of-sight and reflective conditions. In other example embodiments, the UE may detect important changes in the environment that the UE is currently located in. For instance, the changes in the environment detected by the UE may include changes in line-of-sight (LOS)/NLOS ratios and/or multipath reflections. Once these changes are detected, the UE may trigger the fine-tuning dataset request.

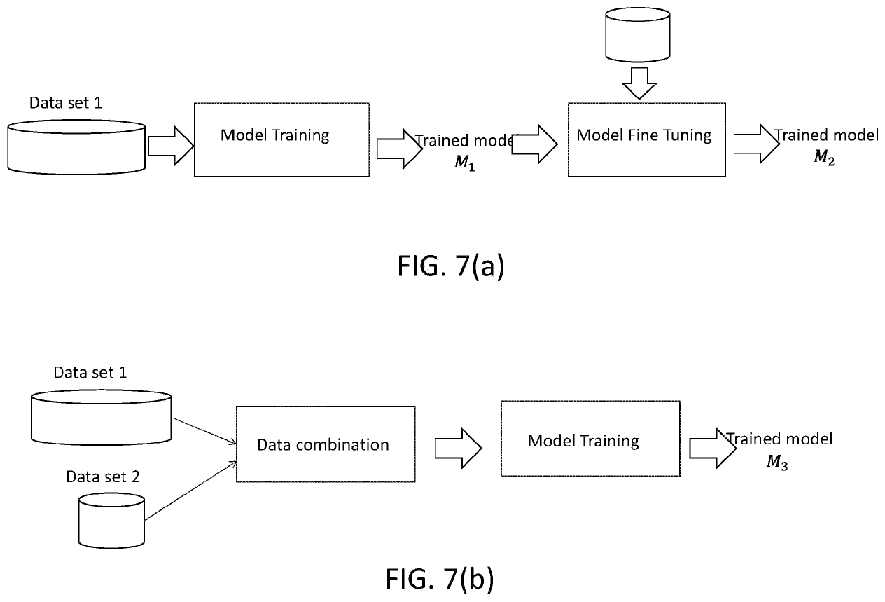

In other example embodiments, the network may request the UE to indicate a preference for a particular dataset for model fine-tuning. For instance, FIG. 7(a) illustrates an example model fine-tuning procedure, according to certain example embodiments, and FIG. 7(b) illustrates an example model tuning with a mixed dataset, according to certain example embodiments. As illustrated in FIG. 7(a), at 700, dataset 1 may be received and used for model training via an AI/ML model that is hosted/deployed at the UE or network (gNB)/LMF. Once training has been completed, at 705, a trained model M₁ may be obtained. At 705, trained model Mi may be fed back into the AI/ML model for model fine-tuning. At 710, dataset 2 may be received by the AI/ML model, and model fine-tuning of model M₁ may be performed with dataset 2. At 715, once the model fine-tuning has been completed, a second trained model M₂ may be obtained.

As illustrated in FIG. 7(b), at 720, model tuning may be performed with a mixed dataset which may include a combination of dataset 1 and dataset 2. Once dataset 1 and dataset 2 have been combined, at 725, model training may be performed with the combined dataset to obtain trained model M₃.

According to certain example embodiments, the UE may request the preferred dataset based on a mobility profile, estimates of channel time and frequency selectivity (e.g., in terms of going through various clutter zones), overhead calculation for an initial dataset, and/or fine-tuning dataset, as compared to a mixed dataset. In certain example embodiments, the mobility profile may include mobility patterns over time, or various regions within the network area that the UE frequently visits, etc. Additionally, overhead calculation may include the size of the initial dataset shared with the UE along with the amount of data samples that need to be shared in future for model fine-tuning or update. Further, the network may minimize overhead based on how frequently data samples are shared with the UE for model fine-tuning. According to some example embodiments, the network may optionally provide additional information along with the dataset preference request in terms of dataset size, input/output parameters, and other parameters for initial fine-tuning and mixed datasets. In other example embodiments, the network may provide a model training dataset based on the UE's preference. Additionally, if the UE indicates a preference for fine-tuning, the network may request implementation details related to the fine-tuning mechanism. In certain example embodiments, the implementation details may include whether hard-tuning is applied with model weights updated, new neural network layers are trained with increased model complexity, etc. In other example embodiments, rather than requesting the UE fine-tuning mechanism, the network may indicate its preference in terms of which mechanism should be applied for fine-tuning along with sharing the initial and/or fine-tuning dataset. In further example embodiments, rather than requesting a preference from the UE, the network may indicate the preference in terms of whether fine-tuning should be applied, or the model should be trained/re-trained using the mixed dataset, along with sharing the mixed dataset including samples collected from multiple environmental settings. In certain example embodiments, the same methods illustrated in FIG. 7(a) and 7(b) may be applied to initial model training where either the fine-tuning mechanism or the UE preference related to dataset may be requested by the network to provide the initial dataset for model training.

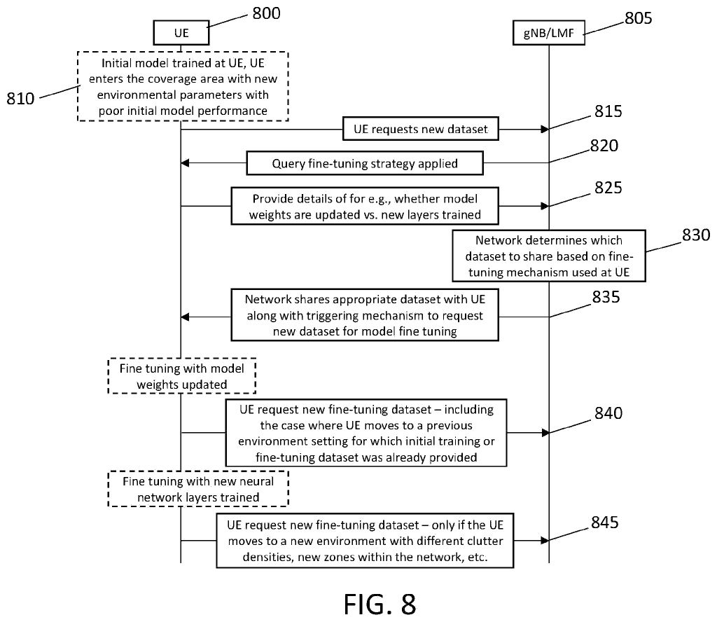

FIG. 8 illustrates an example signal flow between a UE 800 and gNB/LMF 805, according to certain example embodiments. For instance, FIG. 8 illustrates signaling between the UE 800 and the gNB/LMF 805 (i.e., network) where the gNB/LMF 805 is requesting information from the UE 800 related to which fine-tuning mechanism is applied. Depending on the fine-tuning mechanisms used, the gNB/LMF 805 may share the appropriate dataset, along with possible triggering mechanisms (i.e., conditions) for requesting new/fine-tuning dataset.

As illustrated in FIG. 8, at 810, the initial model may be trained at the UE 800, and the UE 800 may enter a coverage area with new environmental parameters-including clutter density, height of TRPs, network synchronization/timing errors, network impairments, industrial clutter characteristics, BSs' and UEs' characteristics, etc., with a poor initial model performance. At 815, the UE 800 may request the gNB/LMF 805 for a new dataset (e.g., dataset that has different environmental parameters and characteristics; new data samples collected from the new environment). At 820, in response to the UE's 800 request, the gNB/LMF 805 may transmit a query to the UE 800 for the fine-tuning policy applied by the UE 800. In response to the query, at 825, the UE 800 may provide the gNB/LMF 805 with details of whether model weights are updated, or new neural layers are trained. For instance, the UE 800 may provide the gNB/LMF 805 with information of whether the fine-tuning policy is updated using a model weight updating operation, or whether the fine-tuning policy is updated using a new neural layer training operation. At 830, the gNB/LMF 805 may determine which dataset (i.e., model dataset) to share with the UE 800 based on the tuning mechanism (i.e., tuning policy) that is used by the UE 800. At 835, the gNB/LMF 805 may transmit, to the UE 800, the model dataset and a triggering mechanism or some indication of the triggering mechanism for the UE 800 to request a new dataset for model fine-tuning. According to certain example embodiments, the triggering mechanism may trigger a request for an updated fine-tuning dataset for one of two cases including, for example, triggering the request when the UE moves from a current environment to a previous environment. Another case may include triggering the request when the UE moves from its current environment to a new environment.

As illustrated in FIG. 8, according to certain example embodiments, when the fine-tuning policy applied by the UE 800 is updated using model weight updating, the UE 800 may, at 840, request a new fine-tuning dataset. In some example embodiments, the new fine-tuning dataset may include labeled samples collected from the new environment that the UE is moving towards. The new environment might have different clutter densities, network errors, etc. For instance, in certain example embodiments, the UE 800 may use the triggering mechanism to request the new fine-tuning dataset when the UE moves from a current environment setting to a previous environment setting for which initial training or a fine-tuning dataset was already provided. In other example embodiments, when the fine-tuning policy applied by the UE 800 is updated using new neural network layer training, the UE 800 may at 845, request a new fine-tuning dataset. For instance, in certain example embodiments, the UE 800 may use the triggering mechanism to request the new fine-tuning dataset when the UE moves from a current environment setting to a new environment with different clutter densities and/or new zones within the network.

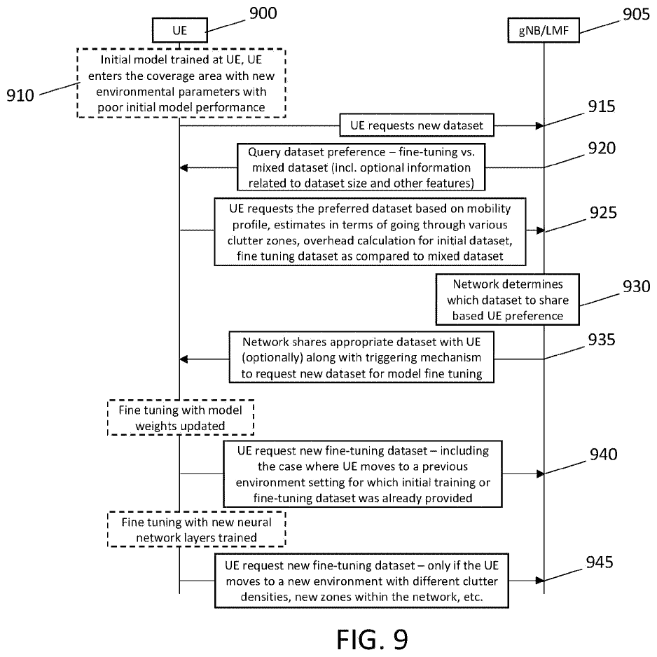

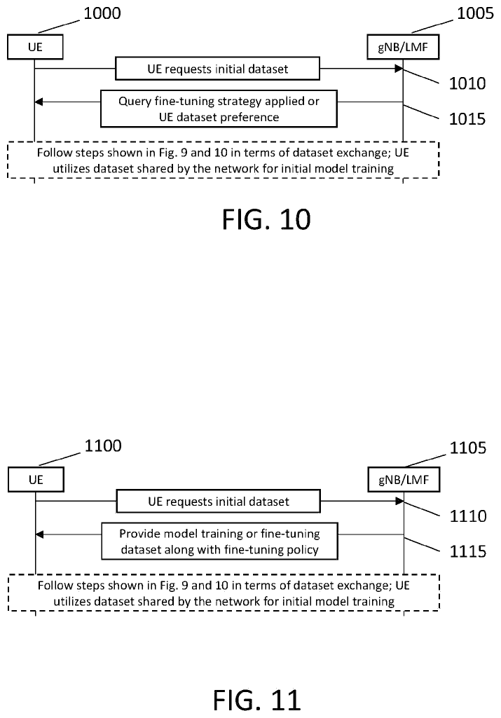

FIG. 9 illustrates another example signal flow between UE 900 and gNB/LMF 905 (i.e., network), according to certain example embodiments. For instance, FIG. 9 illustrates a signaling flow between UE 900 and gNB/LMF 905 where the UE preference related to the dataset is signaled. Upon receiving a request at UE 900 from the gNB/LMF 905 for the dataset preference, along with possible assistance information related to dataset size for fine-tuning and mixed datasets, the UE 900 may estimate which dataset would require the least amount of signaling. The UE 900 may also take the added computational complexity for training and inference with the use of the significantly larger mixed dataset in comparison to the smaller dataset used for fine-tuning.

As illustrated in FIG. 9, at 910, the initial model may be trained at the UE 900, and the UE 900 may enter a coverage area with new environmental parameters with a poor initial model performance. At 915, the UE 900 may request the gNB/LMF 905 for a new dataset. At 920, in response to the UE's 900 request, the gNB/LMF 905 may transmit a query to the UE 900 requesting dataset preference indicating one of fine-tuning dataset, or mixed dataset. According to certain example embodiments, the query sent by the gNB/LMF 905 may include additional information related to dataset size for fine-tuning and mixed datasets.

At 925, the UE 900 may transmit a request to the gNB/LMF 905 requesting the UE's 900 preferred dataset indicating one of fine-tuning dataset, or mixed dataset. In some example embodiments, the UE's 900 request may be sent based on a mobility profile, estimates in terms of going through various clutter zones, overhead calculations for an initial dataset, and/or a fine-tuning dataset as compared to a mixed dataset. As described above, the mobility profile may include mobility patterns over time, or various regions within the network area that the UE frequently visits, etc. Additionally, overhead calculation may include the size of the initial dataset shared with the UE along with the amount of data samples that need to be shared in future for model fine-tuning or update. Further, the network may minimize overhead based on how frequently data samples are shared with the UE for model fine-tuning. At 930, the gNB/LMF 905 may determine which dataset to share/send to the UE 900 based on the UE's 900 preference. Once the determination has been made, the gNB/LMF 905 may transmit to the UE 900, the model dataset along with a triggering mechanism to request a new dataset for model fine-tuning. According to certain example embodiments, the triggering mechanism may trigger a request for an updated fine-tuning dataset for one of two cases including, for example, triggering the request when the UE moves from a current environment to a previous environment. Another case may include triggering the request when the UE moves from its current environment to a new environment.

As illustrated in FIG. 9, according to certain example embodiments, when the fine-tuning strategy applied by the UE 900 is updated using model weight updating, the UE 900 may at 940, request a new fine-tuning dataset. For instance, in certain example embodiments, the UE 900 may use the triggering mechanism to request the new fine-tuning dataset when the UE moves from a current environment setting to a previous environment setting for which initial training or a fine-tuning dataset was already provided. In other example embodiments, when the fine-tuning strategy applied by the UE 900 is updated using new neural network layer training, the UE 900 may at 945, request a new fine-tuning dataset. For instance, in certain example embodiments, the UE 900 may use the triggering mechanism to request the new fine-tuning dataset when the UE moves from a current environment setting to a new environment with different clutter densities and/or new zones within the network.

FIG. 10 illustrates an example signal flow between UE 1000 and the gNB/LMF 1005, according to certain example embodiments. For instance, FIG. 10 illustrates a scenario where the method may be applied for the initial dataset exchange and model training. Like FIG. 8, the UE 1000 may at 1010, transmit a request to the gNB/LMF 1005 requesting an initial dataset for model training. In certain example embodiments, the initial dataset may include model inputs and outputs that are used to train an ML model. The initial dataset might be a limited dataset used to train an initial model, which could be fine-tuned later, depending on UE and network requirements. Additionally, the initial dataset may correspond to the first dataset used in the initial training of the AI/ML model used in the first dataset. The initial dataset may be used to train the AI/ML model, and the new dataset may be used to fine-tune the same AI/ML model. At 1015, the gNB/LMF 10005 may, in response to the UE's 1000 request, transmit a query to the UE 1000 a query for the fine-tuning strategy applied by the UE 1000 or the UE's 1000 dataset preference. According to certain example embodiments, the following operations in the signal flow of FIG. 10 may be similar to the operations illustrated in FIGS. 8 and 9, as described above in terms of dataset exchange. That is, the UE may utilize the dataset shared by the network for initial model training.

FIG. 11 illustrates an example signal flow between UE 1100 and gNB/LMF 1105, according to certain example embodiments. For instance, FIG. 11 illustrates a scenario where gNB/LMF (i.e., network) 1105 may provide the fine-tuning strategy to the UE 1100 along with the appropriate dataset. Rather than the network receiving UE fine-tuning strategy or preference related to the dataset, the network may signal the fine-tuning strategy along with the dataset. The fine-tuning strategy may also include appropriate triggering configurations/mechanisms for requesting new fine-tuning datasets.

As illustrated in FIG. 11, at 1110, the UE 1100 may transmit a request to the gNB/LMF 1105 requesting an initial dataset for model training. At 1115, the gNB/LMF 1105 may, in response to UE's 1100 request, transmit a model training or fine-tuning dataset along with a fine-tuning strategy to UE 1100. According to certain example embodiments, the following operations in the signal flow of FIG. 11 may be similar to the operations illustrated in FIGS. 8 and 9, as described above in terms of dataset exchange. That is, the UE may utilize the dataset shared by the network for initial model training.

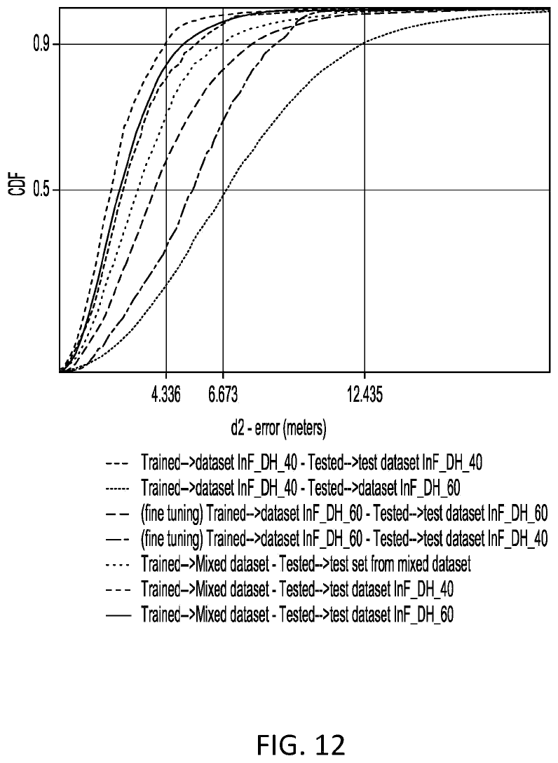

FIG. 12 illustrates an example model performance evaluation, according to certain example embodiments. In particular, FIG. 12 illustrates a model performance evaluation in terms of horizontal positioning accuracy for an initial model trained using dataset 1 and tested using dataset 2. Fine-tuning evaluations may also be conducted with model weight update, and the fine-tuned model may be re-tested using the initial dataset to show the performance degradation that occurs-depending on the parameters used for fine-tuning. In some example embodiments, the model performance when a mixed dataset (with 2× the size of the initial dataset) is used is also shown in FIG. 12. From the results, it can be observed that fine-tuning may significantly degrade the performance of the model in the environmental setting where the model was initially trained. Additionally, the use of a mixed dataset may provide enhanced performance. However, the enhanced performance may come at the cost of a significantly larger dataset exchange overhead between the UE and the network.

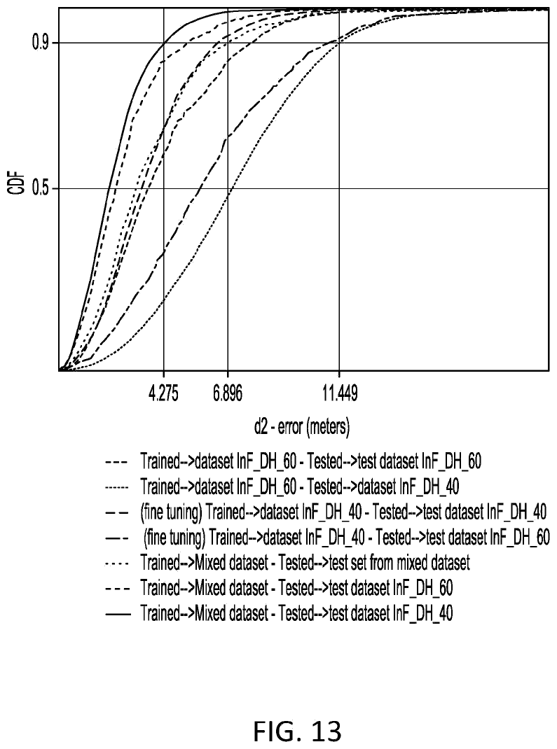

FIG. 13 illustrates another example model performance evaluation according to certain example embodiments. As shown in FIG. 13, similar experiments as with those of FIG. 12 are repeated, except different datasets are used. The result trends may be similar to that of FIG. 12 in terms of fine-tuning improving model performance for the new setting with relatively low overhead (fine-tuning dataset is approximately 20% of the initial dataset).

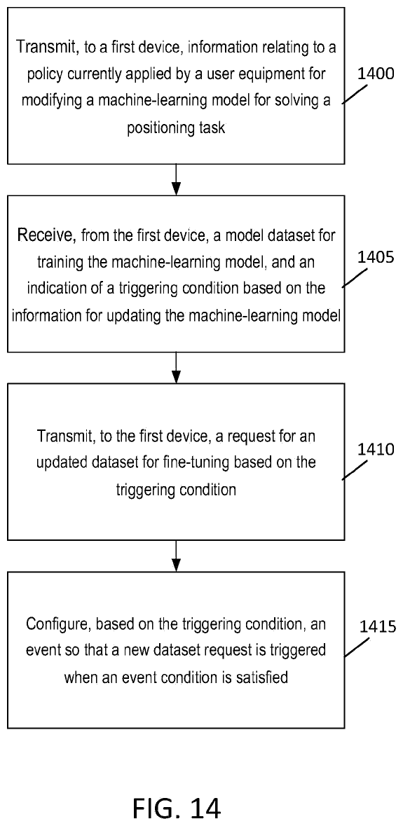

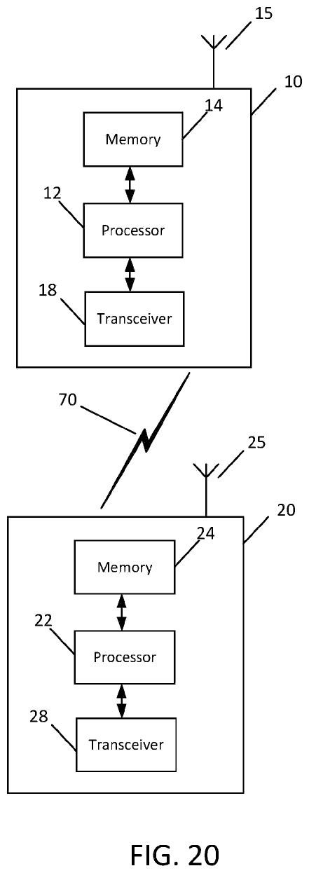

FIG. 14 illustrates an example flow diagram of a method, according to certain example embodiments. In an example embodiment, the method of FIG. 14 may be performed by a network entity, or a group of multiple network elements in a 3GPP system, such as LTE or 5G-NR. For instance, in an example embodiment, the method of FIG. 14 may be performed by a UE similar to one of apparatuses 10 or 20 illustrated in FIG. 20.

According to certain example embodiments, the method of FIG. 14 may include, at 1400, transmitting, to a first device, information relating to a policy currently applied by a user equipment for modifying a machine-learning model for solving a positioning task. The method may also include, at 1405, receiving, from the first device, a model dataset for training the machine-learning model, and an indication of a triggering condition based on the information for updating the machine-learning model. The method may further include, at 1410, transmitting, to the first device, a request for an updated dataset for fine-tuning based on the triggering condition. In addition, the method may include, at 1415, configuring, based on the triggering condition, an event so that a new dataset request is triggered when an event condition is satisfied.

According to certain example embodiments, the information may identify at least one of the following: whether the policy corresponds to updating using a weight updating operation of the machine-learning model; whether the policy corresponds to updating using a neural network layer training operation of a specific part of the machine-learning model; or whether the policy corresponds to freezing machine-learning model weights and attaching an additional neural network layer for a training operation of the machine-learning model. In some example embodiments, According to some example embodiments, the triggering condition may correspond to at least one of the following: triggering the request for the updated dataset for fine-tuning when the user equipment moves to a previous environment from a current environment for which an initial training or a dataset for fine-tuning was already provided; or triggering the request for the updated dataset for fine-tuning when the user equipment moves to a new environment from the current environment. According to other example embodiments, the new environment may include different clutter densities, or new zones within a network compared to a current environment where the user equipment is located. According to further example embodiments, the method may also include transmitting a request to the first device for the model dataset. In addition, the method may also include receiving, from the first device, a query requesting the information related to which policy is currently applied.

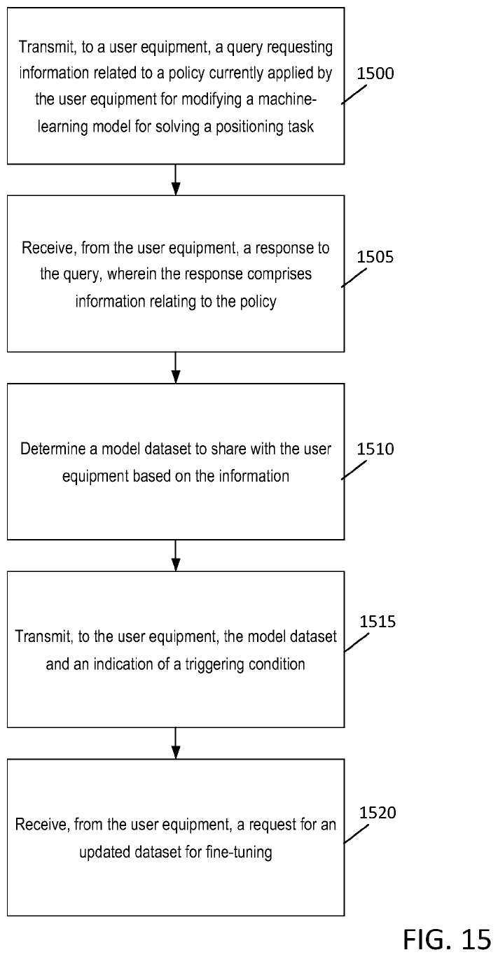

FIG. 15 illustrates an example of a flow diagram of another method, according to certain example embodiments. In an example embodiment, the method of FIG. 15 may be performed by a network entity, or a group of multiple network elements in a 3GPP system, such as LTE or 5G-NR. For instance, in an example embodiment, the method of FIG. 15 may be performed by a network, cell, gNB, LMF, or any other device similar to one of apparatuses 10 or 20 illustrated in FIG. 20.

According to certain example embodiments, the method of FIG. 15 may include, at 1500, transmitting, to a user equipment, a query requesting information related to a policy currently applied by the user equipment for modifying a machine-learning model for solving a positioning task. The method may also include, at 1505, receiving, from the user equipment, a response to the query, wherein the response may include information relating to the policy. The method may further include, at 1510, determining a model dataset to share with the user equipment based on the information. In addition, the method may include, at 1515, transmitting, to the user equipment, the model dataset and an indication of a triggering condition. Further, the method may include, at 1520, receiving, from the user equipment, a request for an updated dataset for fine-tuning.

According to certain example embodiments, the information may identify at least one of the following: whether the policy corresponds to updating using a weight updating operation of the machine-learning model; or whether the policy corresponds to updating using a neural network layer training operation of a specific part of the machine-learning model; or whether the policy corresponds to freezing machine-learning model weights and attaching an additional neural network layer for a training operation of the machine-learning model. According to certain example embodiments, the triggering condition may include at east one of the following: triggering the request for the updated dataset for fine-tuning when the user equipment moves to a previous environment from a current environment for which an initial training or a dataset for fine-tuning was already provided; or triggering the request for the updated dataset for fine-tuning when the user equipment moves to a new environment from the current environment. According to other example embodiments, the new environment may include different clutter densities, or new zones within a network compared to a current environment where the user equipment is located. According to further example embodiments, the method any further include receiving a request from the user equipment for the model dataset.

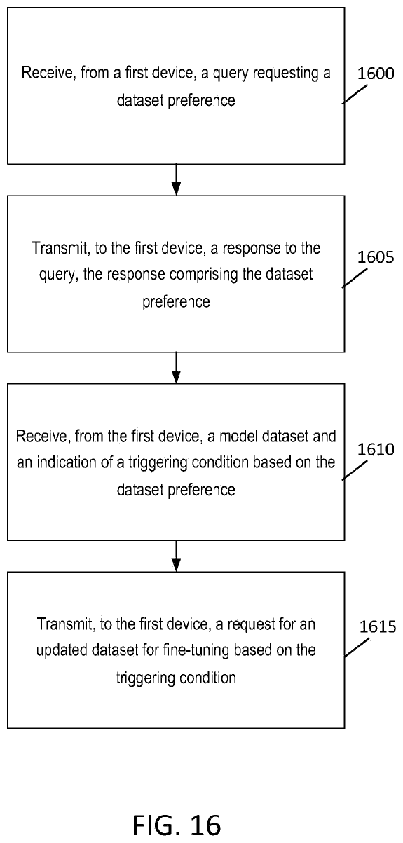

FIG. 16 illustrates an example flow diagram of a method, according to certain example embodiments. In an example embodiment, the method of FIG. 16 may be performed by a network entity, or a group of multiple network elements in a 3GPP system, such as LTE or 5G-NR. For instance, in an example embodiment, the method of FIG. 16 may be performed by a UE similar to one of apparatuses 10 or 20 illustrated in FIG. 20.

According to certain example embodiments, the method of FIG. 16 may include, at 1600, receiving, from a first device, a query requesting a dataset preference. The method may also include, at 1605, transmitting, to the first device, a response to the query, the response including the dataset preference. The method may further include, at 1610, receiving, from the network element, a model dataset and a triggering mechanism based on the dataset preference. In addition, the method may include, at 1615, receiving, from the first device, a model dataset and an indication of a triggering condition based on the dataset preference. According to other example embodiments, the method may include, at 1620, transmitting, to the first device, a request for an updated dataset for fine-tuning based on the triggering condition.

In certain example embodiments, the dataset preference may include at least one of the following: a preference for a dataset for fine-tuning; or a preference for a mixed dataset including a plurality of different datasets. In some example embodiments, the triggering condition may include at least one of the following: triggering the request for the updated dataset for fine-tuning when a user equipment moves to a previous environment from a current environment for which an initial training or a dataset for fine-tuning was already provided; or triggering the request for the updated dataset for fine-tuning when the user equipment moves to a new environment from the current environment. In other example embodiments, the method may further include transmitting a request to the first device for the model dataset. In another example embodiments, the dataset preference may be based on a mobility profile of a user equipment, characteristics of a clutter zone where the user equipment is passing through, or an overhead calculation for an initial dataset.

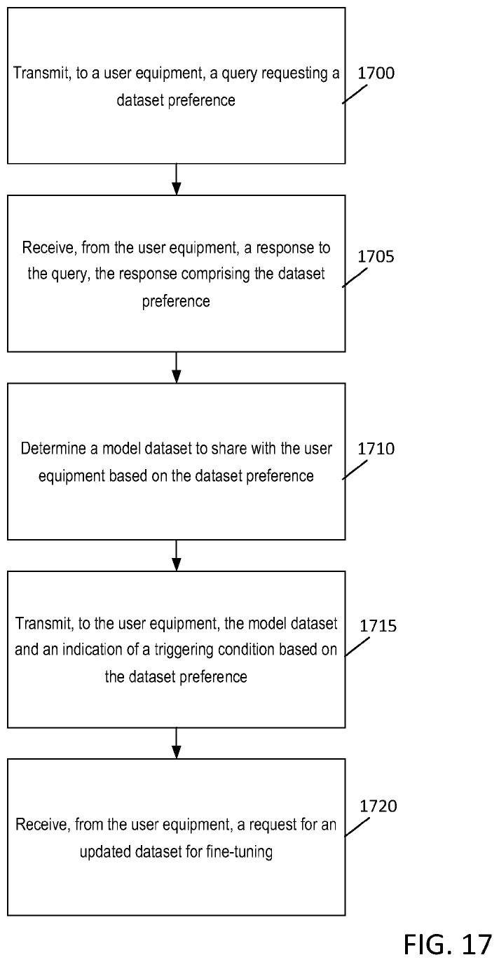

FIG. 17 illustrates an example of a flow diagram of another method, according to certain example embodiments. In an example embodiment, the method of FIG. 17 may be performed by a network entity, or a group of multiple network elements in a 3GPP system, such as LTE or 5G-NR. For instance, in an example embodiment, the method of FIG. 17 may be performed by a network, cell, gNB, LMF, or any other device similar to one of apparatuses 10 or 20 illustrated in FIG. 20.

According to certain example embodiments, the method of FIG. 17 may include, at 1700, transmitting, to a user equipment, a query requesting a dataset preference. The method may also include, at 1705, receiving, from the user equipment, a response to the query, the response including the dataset preference. According to some example embodiments, the UE may transmit the dataset preference without being first asked by the network. The method may further include, at 1710, determining a model dataset to share with the user equipment based on the dataset preference. In addition, the method may include, at 1715, transmitting, to the user equipment, the model dataset and an indication of a triggering condition based on the dataset preference. Further, the method may include, at 1720, receiving, from the user equipment, a request for an updated dataset for fine-tuning.

According to certain example embodiments, the dataset preference may include at least one of the following: a preference for a dataset for fine-tuning; or a preference for a mixed dataset including a plurality of different datasets. According to other example embodiments, the triggering condition may correspond to at least one of the following: triggering the request for the updated dataset for fine-tuning when the user equipment moves to a previous environment from a current environment for which an initial training or a dataset for fine-tuning was already provided; or triggering the request for the updated dataset for fine-tuning when the user equipment moves to a new environment from the current environment. According to some example embodiments, the method may further include receiving, from the user equipment, a request for the model dataset. According to further example embodiments, the dataset preference may be based on a mobility profile of the user equipment, characteristics of a clutter zone where the user equipment is passing through, or an overhead calculation for an initial dataset.

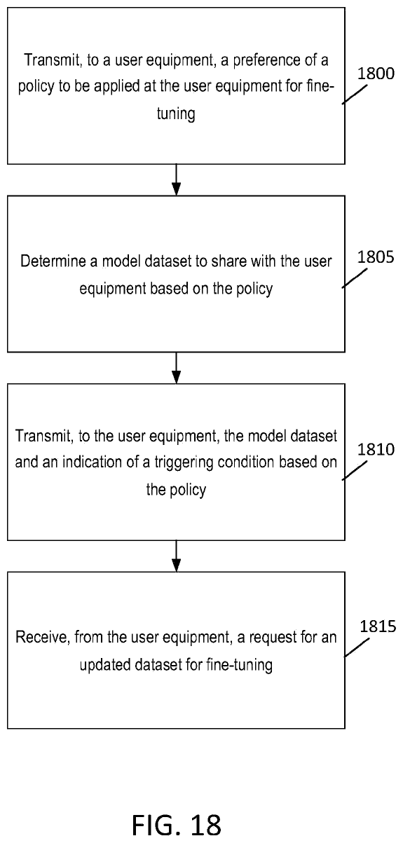

FIG. 18 illustrates an example of a flow diagram of another method, according to certain example embodiments. In an example embodiment, the method of FIG. 18 may be performed by a network entity, or a group of multiple network elements in a 3GPP system, such as LTE or 5G-NR. For instance, in an example embodiment, the method of FIG. 18 may be performed by a network, cell, gNB, LMF, or any other device similar to one of apparatuses 10 or 20 illustrated in FIG. 20.

According to certain example embodiments, the method of FIG. 18 may include, at 1800, transmitting, to a user equipment, a preference of a policy to be applied at the user equipment for fine-tuning. The method may also include, at 1805, determining a model dataset to share with the user equipment based on the policy. The method may further include, at 1810, transmitting, to the user equipment, the model dataset and an indication of a triggering condition based on the policy. In addition, the method may include, at 1815, receiving, from the user equipment, a request for an updated dataset for fine-tuning.

According to certain example embodiments, the preference of the policy to be applied at the user equipment for fine-tuning identifies at least one of the following: whether the policy corresponds to updating using a weight updating operation of the machine-learning model; whether the policy corresponds to updating using a neural network layer training operation of a specific part of the machine-learning model; or whether the policy corresponds to freezing machine-learning model weights and attaching an additional neural network layer for a training operation of the machine-learning model. According to some example embodiments, the triggering condition corresponds to at least one of the following: triggering the request for the updated dataset for fine-tuning when the user equipment moves to a previous environment from a current environment for which an initial training or a dataset for fine-tuning was already provided; or triggering the request for the updated dataset for fine-tuning when the user equipment moves to a new environment from the current environment. According to other example embodiments, the new environment may include different clutter densities, or new zones within a network compared to a current environment where the user equipment is located.

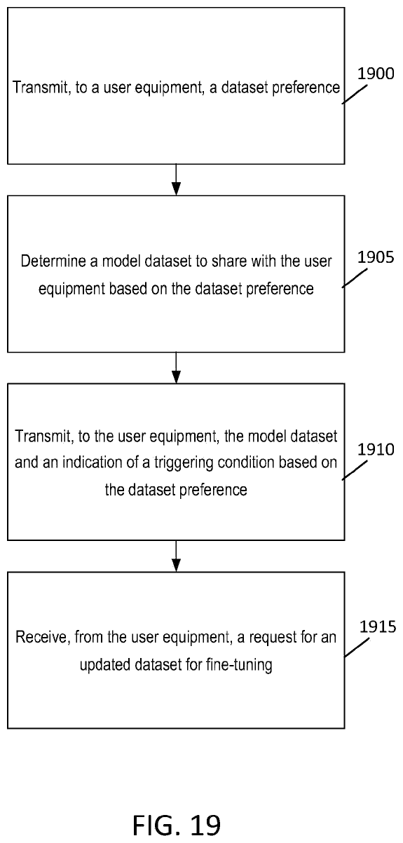

FIG. 19 illustrates an example of a flow diagram of another method, according to certain example embodiments. In an example embodiment, the method of FIG. 19 may be performed by a network entity, or a group of multiple network elements in a 3GPP system, such as LTE or 5G-NR. For instance, in an example embodiment, the method of FIG. 19 may be performed by a network, cell, gNB, LMF, or any other device similar to one of apparatuses 10 or 20 illustrated in FIG. 20.

According to certain example embodiments, the method of FIG. 18 may include, at 1900, transmitting, to a user equipment, a dataset preference. The method may also include, at 1905, determining a model dataset to share with the user equipment based on the dataset preference. The method may further include, at 1910, transmitting, to the user equipment, the model dataset and an indication of a triggering condition based on the dataset preference. In addition, the method may include, at 1915, receiving, from the user equipment, a request for an updated dataset for fine-tuning.

According to certain example embodiments, the dataset preference may include at least one of the following: a preference for a dataset for fine-tuning; or a preference for a mixed dataset including a plurality of different datasets. According to other example embodiments, the triggering condition may correspond to at least one of the following: triggering the request for the updated dataset for fine-tuning when the user equipment moves to a previous environment from a current environment for which an initial training or a dataset for fine-tuning was already provided; or triggering the request for the updated dataset for fine-tuning when the user equipment moves to a new environment from the current environment. According to some example embodiments, the method may further include receiving, from the user equipment, a request for the model dataset. According to other example embodiments, the dataset preference may be based on a mobility profile of a user equipment, characteristics of a clutter zone where the user equipment is passing through, or an overhead calculation for an initial dataset.

FIG. 20 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 20.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 20, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 20, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-14 and 16.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-14 and 16.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to transmit, to a first device, information relating to a policy currently applied by the apparatus for modifying a machine-learning model for solving a positioning task. Apparatus 10 may also be configured to receive, from the first device, a model dataset for training the machine-learning model, and an indication of a triggering condition based on the information for updating the machine-learning model. Apparatus 10 may further be configured to transmit, to the first device, a request for an updated dataset for fine-tuning based on the triggering condition. In addition, apparatus 10 may be configured to configure, based on the triggering condition, an event so that a new dataset request is triggered when an event condition is satisfied.

In other example embodiments, apparatus 10 may be controlled by memory 14 and processor 12 to from a first device, a query requesting a dataset preference. Apparatus 10 may also be controlled by memory 14 and processor 12 to transmit, to the first device, a response to the query, the response including the dataset preference. Apparatus 10 may further be controlled by memory 14 and processor 12 to receive, from the first device, a model dataset and an indication of a triggering condition based on the dataset preference. In addition, apparatus 10 may be controlled by memory 14 and processor 12 to transmit, to the first device, a request for an updated dataset for fine-tuning based on the triggering condition.

As illustrated in the example of FIG. 20, apparatus 20 may be a network, core network element, or element in a communications network or associated with such a network, such as a gNB, NW, or LMF. It should be noted that one of ordinary skill in the art would understand that apparatus 20 may include components or features not shown in FIG. 20.

As illustrated in the example of FIG. 20, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 20, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1-13, 15, and 17-19.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1-13, 15, and 17-19.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 transmit to a user equipment, a query requesting information related to a policy currently applied by the user equipment for modifying a machine-learning model for solving a positioning task. Apparatus 20 may also be controlled by memory 24 and processor 22 to receive, from the user equipment, a response to the query, wherein the response includes information relating to the policy. Apparatus 20 may further be controlled by memory 24 and processor 22 to determine determining a model dataset to share with the user equipment based on the information. In addition, apparatus 20 may be controlled by memory 24 and processor 22 to transmit, to the user equipment, the model dataset and an indication of a triggering condition. Further, apparatus 20 may be controlled by memory 24 and processor 22 to receive, from the user equipment, a request for an updated dataset for fine-tuning.

In other example embodiments, apparatus 20 may be controlled by memory 24 and processor 22 to transmit, to a user equipment, a query requesting a dataset preference. Apparatus 20 may also be controlled by memory 24 and processor 22 to receive, from the user equipment, a response to the query, the response including the dataset preference. Apparatus 20 may further be controlled by memory 24 and processor 22 to determine a model dataset to share with the user equipment based on the dataset preference. In addition, apparatus 20 may be controlled by memory 24 and processor 22 to transmit, to the user equipment, the model dataset and an indication of a triggering condition based on the dataset preference. Further, apparatus 20 may be controlled by memory 24 and processor 22 to receive, from the user equipment, a request for an updated dataset for fine-tuning.

In other example embodiments, apparatus 20 may be controlled by memory 24 and processor 22 to transmit to a user equipment, a preference of a policy to be applied at the user equipment for fine-tuning. Apparatus 20 may also be controlled by memory 24 and processor 22 to receive, from the user equipment, a response to the query, the response including the dataset preference. Apparatus 20 may further be controlled by memory 24 and processor 22 to determine a model dataset to share with the user equipment based on the policy. In addition, apparatus 20 may be controlled by memory 24 and processor 22 to transmit, to the user equipment, the model dataset and an indication of a triggering condition based on the policy. Further, apparatus 20 may be controlled by memory 24 and processor 22 to receive, from the user equipment, a request for an updated dataset for fine-tuning.

In further example embodiments, apparatus 20 may be controlled by memory 24 and processor 22 to transmit, to a user equipment, a dataset preference. Apparatus 20 may also be controlled by memory 24 and processor 22 to determine a model dataset to share with the user equipment based on the dataset preference. Apparatus 20 may further be controlled by memory 24 and processor 22 to transmit, to the user equipment, the model dataset and an indication of a triggering condition based on the dataset preference. In addition, apparatus 20 may be controlled by memory 24 and processor 22 to receive, from the user equipment, a request for an updated dataset for fine-tuning

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for transmitting, to a first device, information relating to a policy currently applied by the apparatus for modifying a machine-learning model for solving a positioning task. The apparatus may also include means for receiving, from the first device, a model dataset for training the machine-learning model, and an indication of a triggering condition based on the information for updating the machine-learning model. The apparatus may further include means for transmitting, to the first device, a request for an updated dataset for fine-tuning based on the triggering condition. In addition, the apparatus may include means for configuring, based on the triggering condition, an event so that a new dataset request is triggered when an event condition is satisfied.

Certain example embodiments may also be directed to an apparatus that includes means for transmitting, to a user equipment, a query requesting information related to a policy currently applied by the user equipment for modifying a machine-learning model for solving a positioning task. The apparatus may also include means for receiving, from the user equipment, a response to the query, wherein the response including information relating to the policy. The apparatus may further include means for determining a model dataset to share with the user equipment based on the information. In addition, the apparatus may include means for transmitting, to the user equipment, the model dataset and an indication of a triggering condition. Further, the apparatus may include means for receiving, from the user equipment, a request for an updated dataset for fine-tuning.

Certain example embodiments may further be directed to an apparatus that includes means for receiving, from a first device, a query requesting a dataset preference. The apparatus may also include means for transmitting, to the first device, a response to the query, the response including the dataset preference. The apparatus may further include means for receiving, from the first device, a model dataset and an indication of a triggering condition based on the dataset preference. In addition, the apparatus may include means for transmitting, to the first device, a request for an updated dataset for fine-tuning based on the triggering condition.

Certain example embodiments may further be directed to an apparatus that includes means for transmitting, to a user equipment, a query requesting a dataset preference. The apparatus may also include means for receiving, from the user equipment, a response to the query, the response including the dataset preference. The apparatus may further include means for determining a model dataset to share with the user equipment based on the dataset preference. In addition, the apparatus may include means for transmitting, to the user equipment, the model dataset and an indication of a triggering condition based on the dataset preference. Further, the apparatus may include means for receiving, from the user equipment, a request for an updated dataset for fine-tuning.

Certain example embodiments may further be directed to an apparatus that includes means for transmitting, to a user equipment, a preference of a policy to be applied at the user equipment for fine-tuning. The apparatus may also include means for determining a model dataset to share with the user equipment based on the policy. The apparatus may further include means for transmitting, to the user equipment, the model dataset and an indication of a triggering condition based on the policy. In addition, the apparatus may include means for receiving, from the user equipment, a request for an updated dataset for fine-tuning.

Certain example embodiments may further be directed to an apparatus that includes means for transmitting, to a user equipment, a dataset. The apparatus may also include means for determining a model dataset to share with the user equipment based on the dataset preference. The apparatus may further include means for transmitting, to the user equipment, the model dataset and an indication of a triggering condition based on the dataset preference. In addition, the apparatus may include means for receiving, from the user equipment, a request for an updated dataset for fine-tuning.

Certain example embodiments described herein provide several technical improvements, enhancements, and/or advantages. For instance, in some example embodiments, it may be possible to determine UE location either at the LMF or the UE, utilizing either direct or AI/ML-assisted positioning methods. In other example embodiments, it may be possible to improve model generalization performance by avoiding catastrophic forgetting by using assistance information from the network to the UE. Additionally, it may be possible to reduce overhead in terms of control signaling and dataset exchange for UE-based positioning methods. The method of certain example embodiments may also improve the positioning accuracy of an AI/ML model as compared to conventional approaches, with minimal increase in model complexity/size and computational complexity.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3rd Generation Partnership Project
5th Generation
5GCN 5G Core Network
5GS 5G System
AoA Angle of Arrival
BS Base Station
CSI Channel State Information
DL Downlink
eNB Enhanced Node B
E-UTRAN Evolved UTRAN
gNB 5G or Next Generation NodeB
LMF Location Management Function
LTE Long Term Evolution
ML Machine Learning
NR New Radio
RSRP Reference Signal Received Power
SVM Support State Information
ToA Time of Arrival
UE User Equipment
UL Uplink

1-30. (canceled)

31. An apparatus, comprising:
at least one processor; and
at least one memory comprising computer program code, the at least one memory and the computer program code configured, with the at least one processor to cause the apparatus at least to transmit, to a first device, information relating to a policy currently applied by the apparatus for modifying a machine-learning model for solving a positioning task;
receive, from the first device, a model dataset for training the machine-learning model, and an indication of a triggering condition based on the information for updating the machine-learning model;
transmit, to the first device, a request for an updated dataset for fine-tuning based on the triggering condition; and
configure, based on the triggering condition, an event so that a new dataset request is triggered when an event condition is satisfied.

32. The apparatus according to claim 31, wherein the information identifies at least one of the following:
whether the policy corresponds to updating using a weight updating operation of the machine-learning model,
whether the policy corresponds to updating using a neural network layer training operation of a specific part of the machine-learning model, or
whether the policy corresponds to freezing machine-learning model weights and attaching an additional neural network layer for a training operation of the machine-learning model.

33. The apparatus according to claim 31, wherein the triggering condition corresponds to at least one of the following:
triggering the request for the updated dataset for fine-tuning when the apparatus moves to a previous environment from a current environment for which an initial training or a dataset for fine-tuning was already provided, or
triggering the request for the updated dataset for fine-tuning when the apparatus moves to a new environment from the current environment.

34. The apparatus according to claim 33, wherein the new environment comprises different clutter densities, or new zones within a network compared to a current environment where the apparatus is located.

35. The apparatus according to claim 31, wherein the at least one memory and the computer program code are further configured, with the at least one processor to cause the apparatus at least to:
transmit a request to the first device for the model dataset.

36. The apparatus according to claim 31, wherein the at least one memory and the computer program code are further configured, with the at least one processor to cause the apparatus at least to:
receive, from the first device, a query requesting the information related to which policy is currently applied.

37. An apparatus, comprising:
at least one processor; and
at least one memory comprising computer program code,
the at least one memory and the computer program code configured, with the at least one processor to cause the apparatus at least to
transmit, to a user equipment, a query requesting information related to a policy currently applied by the user equipment for modifying a machine-learning model for solving a positioning task;
receive, from the user equipment, a response to the query, wherein the response comprises information relating to the policy;
determine a model dataset to share with the user equipment based on the information;
transmit, to the user equipment, the model dataset and an indication of a triggering condition; and
receive, from the user equipment, a request for an updated dataset for fine-tuning.

38. The apparatus according to claim 37, wherein the information identifies at least one of the following:
whether the policy corresponds to updating using a weight updating operation of the machine-learning model,
whether the policy corresponds to updating using a neural network layer training operation of a specific part of the machine-learning model, or
whether the policy corresponds to freezing machine-learning model weights and attaching an additional neural network layer for a training operation of the machine-learning model.

39. The apparatus according to claim 37, wherein the triggering condition corresponds to at least one of the following:
triggering the request for the updated dataset for fine-tuning when the user equipment moves to a previous environment from a current environment for which an initial training or a dataset for fine-tuning was already provided, or
triggering the request for the updated dataset for fine-tuning when the user equipment moves to a new environment from the current environment.

40. The apparatus according to claim 39, wherein the new environment comprises different clutter densities, or new zones within a network compared to a current environment where the user equipment is located.

41. The apparatus according to claim 37, wherein the at least one memory and the computer program code are further configured, with the at least one processor to cause the apparatus at least to:
receive a request from the user equipment for the model dataset.

42. An apparatus, comprising:
at least one processor; and
at least one memory comprising computer program code,
the at least one memory and the computer program code configured, with the at least one processor to cause the apparatus at least to
receive, from a first device, a query requesting a dataset preference;
transmit, to the first device, a response to the query, the response comprising the dataset preference;
receiving, from the first device, a model dataset and an indication of a triggering condition based on the dataset preference; and
transmitting, to the first device, a request for an updated dataset for fine-tuning based on the triggering condition.

43. The apparatus according to claim 42, wherein the dataset preference comprises at least one of the following:
a preference for a dataset for fine-tuning, or
a preference for a mixed dataset comprising a plurality of different datasets.

44. The apparatus according to claim 42, wherein the triggering condition corresponds to at least one of the following:
triggering the request for the updated dataset for fine-tuning when a user equipment moves to a previous environment from a current environment for which an initial training or a dataset for fine-tuning was already provided, or
triggering the request for the updated dataset for fine-tuning when the user equipment moves to a new environment from the current environment.

45. The apparatus according to claim 42, wherein the at least one memory and the computer program code are further configured, with the at least one processor to cause the apparatus at least to:
transmit a request to the first device for the model dataset.

46. The apparatus according to claim 42, wherein the dataset preference is based on a mobility profile of a user equipment, characteristics of a clutter zone where the user equipment is passing through, or an overhead calculation for an initial dataset.

47. An apparatus, comprising:
at least one processor; and
at least one memory comprising computer program code, the at least one memory and the computer program code configured, with the at least one processor to cause the apparatus at least to
transmit, to a user equipment, a query requesting a dataset preference;
receive, from the user equipment, a response to the query, the response comprising the dataset preference;
determine a model dataset to share with the user equipment based on the dataset preference;
transmit, to the user equipment, the model dataset and an indication of a triggering condition based on the dataset preference; and
receive, from the user equipment, a request for an updated dataset for fine-tuning.

48. The apparatus according to claim 47, wherein the dataset preference comprises at least one of the following:
a preference for a dataset for fine-tuning, or
a preference for a mixed dataset comprising a plurality of different datasets.

49. The apparatus according to claim 47, wherein the triggering condition corresponds to at least one of the following:
triggering the request for the updated dataset for fine-tuning when the user equipment moves to a previous environment from a current environment for which an initial training or a dataset for fine-tuning was already provided, or
triggering the request for the updated dataset for fine-tuning when the user equipment moves to a new environment from the current environment.

50. The apparatus according to claim 47, wherein the at least one memory and the computer program code are further configured, with the at least one processor to cause the apparatus at least to:
receive, from the user equipment, a request for the model dataset.

51. The apparatus according to claim 47, wherein the dataset preference is based on a mobility profile of the user equipment, characteristics of a clutter zone where the user equipment is passing through, or an overhead calculation for an initial dataset.

52-92. (canceled)
